(19) United States
(12) Patent Application Publication
(10) Pub. No.: US 2007/0146383 A1
(43) Pub. Date: Jun. 28, 2007

(54) Color uniformity system

(75) Inventor: Gokalp Bayramoglu, Pleasanton, CA (US)

Correspondence Address: Gokalp Bayramoglu, 5202 Independence Dr., Pleasanton, CA, 94566, US

(73) Assignee: Awa Consulting Inc.

(21) Appl. No.: 11/593,074

(22) Filed: Nov. 6, 2006

Related U.S. Application Data
(60) Provisional application No. 60/749,485, filed on Dec. 13, 2005.

(51) Int. Cl. G09G 5/02

(52) U.S. Cl. 345/589

(57) ABSTRACT

A color uniformity system for correcting color uniformity problems that exist with today's display devices. The inventive device includes a device to measure the color uniformity of the display device and software that uses the information from the measuring system to correct the color uniformity problem on the display device. Probe assembly has so many probes on it that is placed on the display and captures the color information on the display. Measuring assembly measures the color of the signal that comes from the probe assembly. Processor uses the color information from the measuring assembly and also communicates with the host system where the display device is driven from. Software resides on the host system and uses the stored color information to correct the color data that is applied to display device. Hardware unit that resides in the display device and performs color calculations if they are not done in the software.

### BACKGROUND OF THE INVENTION

1. Field of the Invention

This application claims the benefit of U.S. Provisional Application No. 60/749,485. The present invention relates generally to color uniformity system and more specifically it relates to a color uniformity system for correcting color uniformity problems that exist with today's display devices.

2. Description of the Related Art

Color correction systems have been in use for years. Typically, color correction systems are comprised of systems that allow end users to calibrate their monitors.

U.S. Pat. No. 7,120,295 discloses a color processing system that characterizes a color output device and produces colors for the same. The system does not address the color uniformity of the output device.

U.S. Pat. No. 7,110,002 B2 discloses a system that corrects the input-output profiles of a projector that has been measured by a colored-light sensor. This system does not address the color uniformity of the output device.

U.S. Pat. No. 7,106,474 B1 teaches how to apply source color transform to the source color image data from a source device color space into interim color image data in an interim color space. The system does not address the color uniformity of the output device.

U.S. Pat. No. 7,106,344 B2 teaches how to use characterized data for an output device to correct color displayed on the output device. This system does not address color uniformity of the output device.

U.S. Pat. No. 7,102,648 B1 discloses a method to characterize a color output device and use the characterized data to change the color rendering on the output device to provide consistent color. This system requires user interface and does not address the color uniformity issue on the output device.

U.S. Pat. No. 7,092,008 B1 discloses a system where display device parameters are available on network and these parameters are used to correct the color displayed on each device. This approach does not address the color uniformity of the output device.

U.S. Pat. No. 7,085,414 B2 teaches how to characterize an output device and take the averaging of chromaticity values and use this information to drive the display. This method does not address the color uniformity of the output device.

U.S. Pat. No. 7,084,881 B1 discloses the system that generates a customized look up table for gamma correction is generated and later used to correct the color sent to display device. This system does not address the color uniformity of the output device.

U.S. Pat. No. 7,068,263 B2 discloses a flat panel color calibration system that includes a lens prism optic able to pass a narrow, perpendicular, and uniform cone angle of incoming light to a spectrally non-selective photo-detector. The luminance information obtained from the display is used to adjust the flat panel display. The system does not address the color uniformity of the display.

U.S. Pat. No. 7,046,255 B2 discloses a hardware-based accelerated color correction filtering system where the display device is characterized and the device specific information is used to render correct color on the display. This system does not address the color uniformity of the display.

U.S. Pat. No. 7,038,811 B1 teaches a standard device characterization system where a color patch is displayed and then measured and the measured data is stored in memory. This system does not address the color uniformity of the display device.

The main problem with conventional color correction systems is that they do not provide good color uniformity. These products are based on the calibration performed by the user. The calibration process cannot cover the whole screen. Therefore good color uniformity cannot be achieved with current methods. Another problem with the conventional color correction systems is that they require user interface. It is not convenient for end user to perform screen calibration. Another problem with conventional color uniformity system is that they can only cover certain points on the screen. The rest of the screen is interpolated.

While these devices may be suitable for the particular purpose to which they address, they are not as suitable for correcting color uniformity problems that exist with today's display devices. The main problem with conventional color correction systems is that they do not provide good color uniformity. These products are based on the calibration performed by the user. The calibration process cannot cover the whole screen. Therefore good color uniformity cannot be achieved with current methods. Another problem is that they require user interface. It is not convenient for end user to perform screen calibration. Also, another problem is that they can only cover certain points on the screen. The rest of the screen is interpolated.

In these respects, the color uniformity system according to the present invention substantially departs from the conventional concepts and designs of the prior art, and in so doing provides an apparatus primarily developed for the purpose of correcting color uniformity problems that exist with today's display devices.

### SUMMARY OF THE INVENTION

In view of the foregoing disadvantages inherent in the known types of color uniformity system now present in the prior art, the present invention provides a new color uniformity system construction wherein the same can be utilized for correcting color uniformity problems that exist with today's display devices.

The general purpose of the present invention, which will be described subsequently in greater detail, is to provide a new color uniformity system that has many of the advantages of the color uniformity system mentioned heretofore and many novel features that result in a new color uniformity system which is not anticipated, rendered obvious, suggested, or even implied by any of the prior art color uniformity system, either alone or in any combination thereof.

To attain this, the present invention generally comprises a device to measure the color uniformity of the display device and software that uses the information from the measuring system to correct the color uniformity problem on the display device. Probe assembly has so many probes on it that is placed on the display and captures the color information on the display. Measuring assembly measures the color of the signal that comes from the probe assembly. Processor uses the color information from the measuring assembly and also communicates with the host system where the display device is driven from. Software resides on the host system and uses the stored color information to correct the color data that is applied to display device. Hardware unit resides in the display device where it performs color calculations when it is not done by the software.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a color uniformity system that will overcome the shortcomings of the prior art devices.

An object of the present invention is to provide a color uniformity system for correcting color uniformity problems that exist with today's display devices.

Another object is to provide a color uniformity system that will measure the color uniformity of any display device and will use that information to correct any color uniformity issue with the device under test.

Another object is to provide a color uniformity system that will correct the color uniformity problem with display devices so that same color on different spots on the screen will not look in different shade and color.

Another object is to provide a color uniformity system that will correct the color uniformity of screens such that production yield of CRT, LCD, Plasma and any other screen manufacturers will go up and as result, the production cost for the screens will be reduced.

Another object is to provide a color uniformity system that will correct the color uniformity issue on display devices so that people can use these devices for color sensitive applications such as ecommerce applications.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is Probe Assembly.

FIG. 2 is Probe Assembly top view.

FIG. 3 is System Block Diagram.

FIG. 4 is Multiplexer.

FIG. 5 is Characterization.

FIG. 6 is System operation.

### DETAILED DESCRIPTION OF THE INVENTION

Turning now descriptively to the drawings, in which similar reference characters denote similar elements throughout the several views, the attached figures illustrate a color uniformity system, which comprises a device to measure the color uniformity of the display device and a software that uses the information from the measuring system to correct the color uniformity problem on the display device. Probe assembly has so many probes on it that is placed on the display and captures the color information on the display. Measuring assembly measures the color of the signal that comes from the probe assembly. Processor uses the color information from the measuring assembly and also communicates with the host system where the display device is driven from. Software resides on the host system and uses the stored color information to correct the color data that is applied to display device. Hardware unit that resides in the display device and performs color calculations if they are not done in the software.

Probe assembly has so many probes on it that is placed on the display and captures the color information on the display. Probe assembly is a plane of probes and placed on the display device to measure the color at many different points at the same or close approximate time. They are made of light sensitive and color sensitive devices and their main function is to detect the signal and communicate to Measuring Assembly. Probe Assembly can be built using any light detecting material. Its function is to measure the color signal.

Measuring assembly measures the color of the signal that comes from the probe assembly. Measuring System works with the Probe assembly to measure the color of the signal that is captured by the Probe Assembly. Measuring Assembly can be any circuit that measures the color of the signal.

Processor uses the color information from the measuring assembly and also communicates with the host system where the display device is driven from. Processor communicates with the host device that drives the display device. Processor can be designed using any microcontroller that is capable of communicating with the host system.

Software resides on the host system and uses the stored color information to correct the color data that is applied to display device. Software resides on the host system and uses the measured color data to correct the color on the display. Software can be written using any programming language. It can be at application level or driver level on the host system. Software can perform the color shifting.

Hardware unit that resides in the display device and performs color calculations if they are not done in the software. Controller resides in the display device and performs color shifting calculations if they are not performed in the software. Controller can be built using any micro controller that is capable of performing color shifting.

Probe assembly detects the video signal on the display and sends this signal to Measuring assembly. The measuring assembly performs the measurement on the video. Tri-stimulus values of the video signal are measured. These values are sent to Processor unit. The processor unit stores this information in the memory. The processor communicates with the Software. The software receives the stored values from the memory and uses these values to correct the color that is displayed on the screen. The detection of the color can be accomplished by using any color detection technique. Probes are specially designed to be able to detect color from a small area on the screen. Measuring assembly can utilize different color measuring algorithms to detect the signal color. The memory where the tri-sitimulus values are stored can either be volatile or non-volatile memory. The color correction of the live display signal is performed using the stored color values. This operation can either be performed in the software or the controller in the display device. When implemented in the controller, a microcontroller chip is used to execute commands that are stored in the memory unit on the controller.

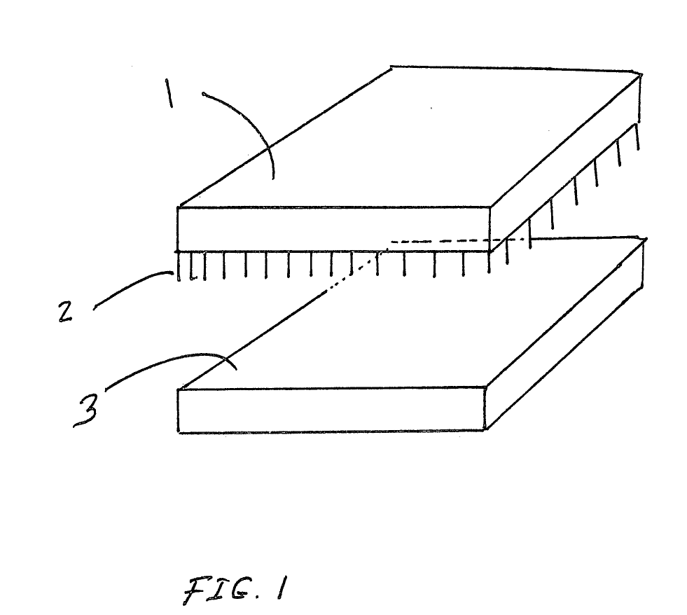

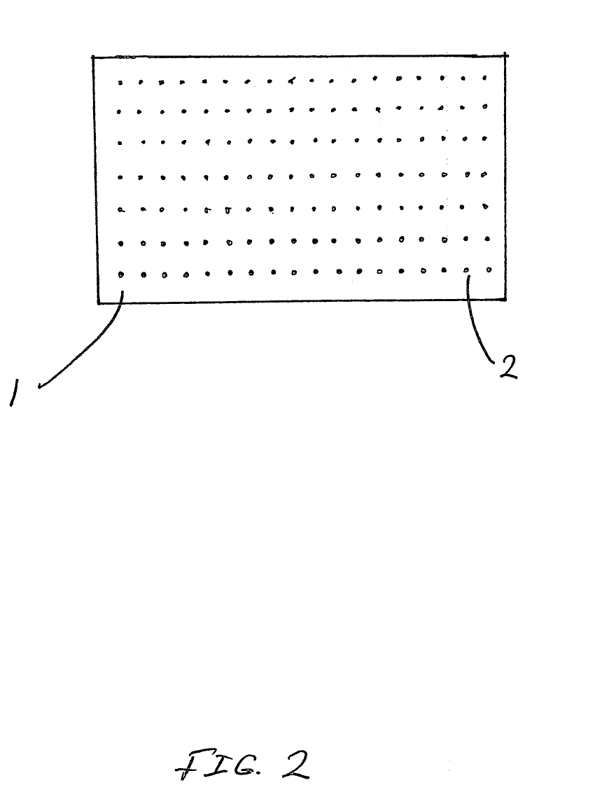

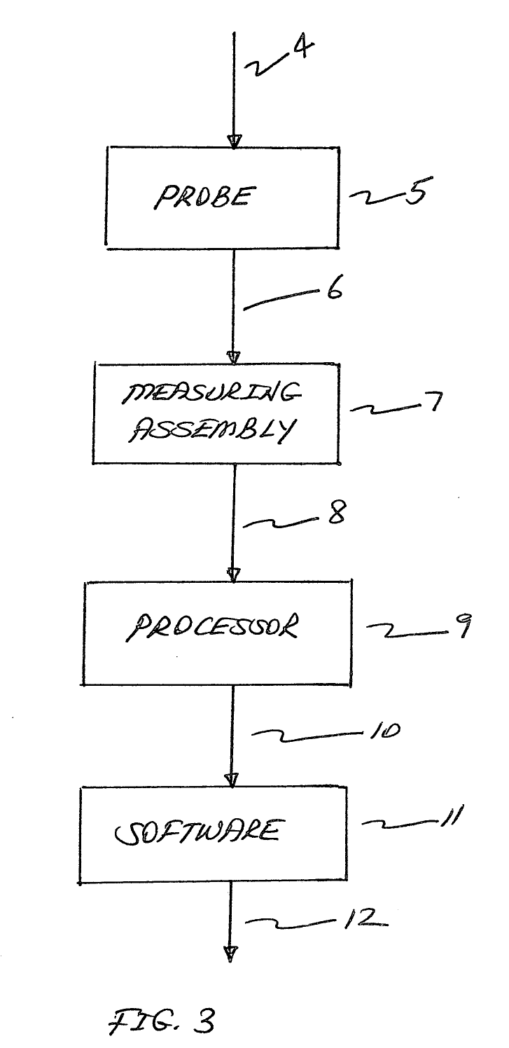

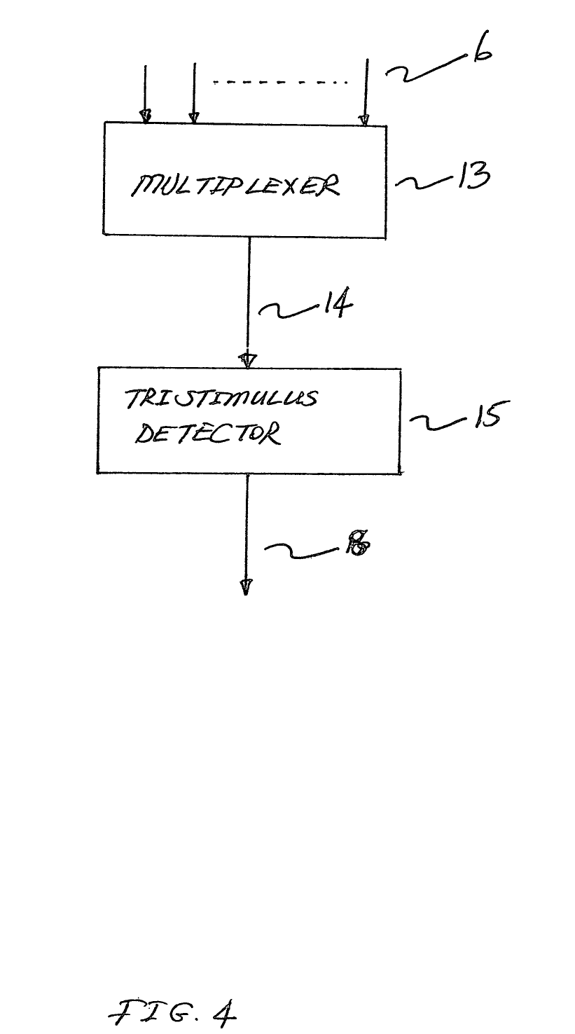

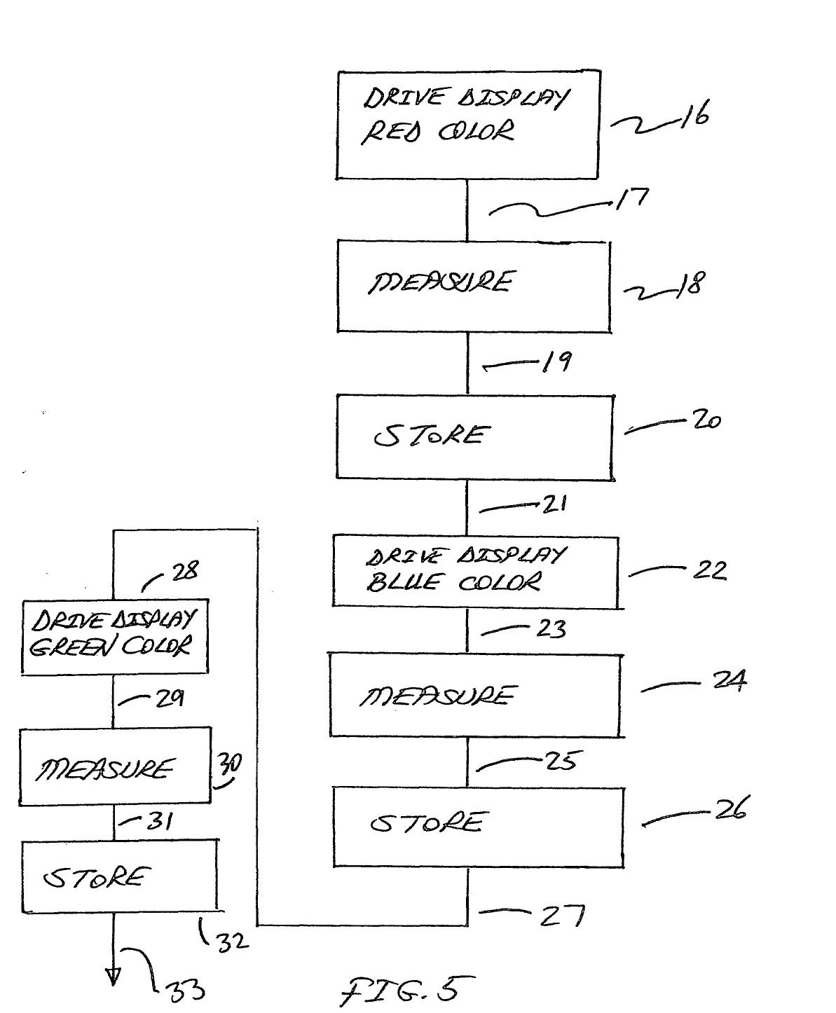

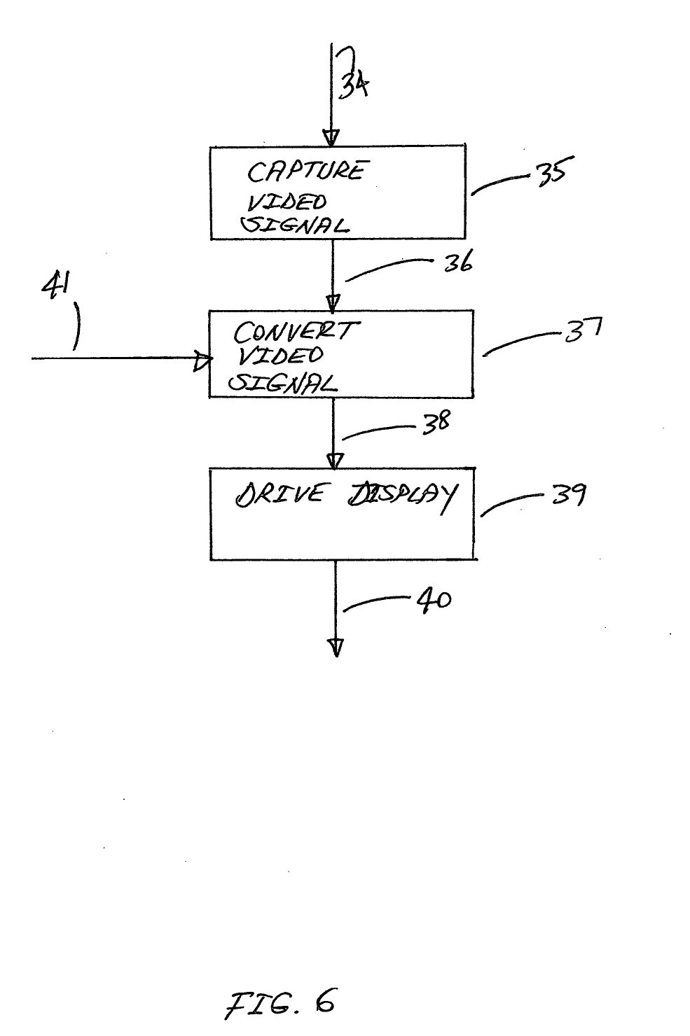

The probe unit 1 and the display device 3 are shown in FIG. 1. Probes 2 are placed on the probe unit 1 such that they cover the whole display area. These probes detect the video signal on the display device and communicate to measuring unit. Probes can be placed on the probe unit 1 as shown in FIG. 1 to cover the whole screen area. Alternatively, a single probe can be used on the tip of a robot arm and can be moved from one location to another on the display device to measure the color. FIG. 2 shows the bottom view of the probe unit. Again, this set up has enough probes to cover the whole display area. Alternative arrangement is possible as described above. FIG. 3 shows the block diagram of the system. The signal 4 from the display arrives to probe at a given location on the display. This signal 4 is captured by the probe 5 and the output 6 of the probe 5 is sent to the measuring assembly 7. The measuring assembly uses different color detection algorithms to detect the color on the screen. The algorithm used here is the Tri-stimulus detection algorithm where the reflectance and the power density of the signal multiplied with each other and the result of this multiplication is further multiplied with the response of a standard IEC observer curves. This yields the tri-stimulus values for the color at each probe location. The output 8 of the measuring assembly is applied to the processor 9. The processor communicates with the software 11 on the host computer. Here it is assumed that host computer and display devices are two separate units and can communicate via standard communication lines such as USB or serial lines. Alternatively, a handheld unit has both the display and the host on the unit therefore a special communication line can be used in that case. Processor unit stores the information in the memory. FIG. 4 shows the details of the measuring unit. When many probes are used, a multiplexer 13 is utilized to select the current probe so that the signal from the location under test can be applied to the tri-stimulus detector 15. The output 8 of the tri-stimulus detector 15 is stored in the memory to be used during the live operation. The algorithm that is used to detect the color values on the different parts of the screen is shown in FIG. 5. Here first the display is driven by the red color in step 16. The color of the screen is measured in step 18 and stored in the memory in step 20. Then the screen is driven by the blue color in step 22 and the output of the screen is measured in step 24 and stored in the memory unit in step 26. The screen is driven with green color in step 28 and the output of the screen is measured in step 30. The measured values are stored in step 33. FIG. 6 shows the algorithm that is used when the screen is driven by a signal. After the screen is characterized, all the color values are stored in the memory unit. The video signal 34 comes from the host computer. This is the video signal that is sent from the host computer to display device. This signal is captured in step 35. The output 36 of the step 35 is compared with the stored value. If the stored value is zero then the captured video signal is not changed. The stored value is added to the video signal value to compensate the difference on the display. Once the new value 38 is calculated the display device is driven by the new signal 40 in step 39. This new signal is the signal that compensates for the different location on the screen. This way, the color will look the same no matter where it is displayed on the screen.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A color uniformity system comprising: a probe unit for measuring the color parameters of the video signal displayed on the screen; a processor unit that calculates color values and communicates with the host computer; a storage unit for storing color values.

2. A system in accordance with claim 1, wherein the probe unit has plurality of probes for detecting and measuring video signal on the display device at plural locations.

3. A system in accordance with claim 1, wherein the probe unit is a robot arm with single probe and moves on the surface of the display device to detect and measure the color of the video signal at plurality of locations to cover the complete screen.

4. A system in accordance with claim 1, wherein the processor unit comprises of a microcontroller with embedded software.

5. A system in accordance with claim 1, wherein the processor unit calculates tri-stimulus values of the color displayed on the screen of the display device.

6. A system in accordance with claim 1, wherein the host computer is a stand alone computer.

7. A system in accordance with claim 1, wherein the communication between the host computer and the processor unit is accomplished by using an existing communication lines available such as Universal Serial Bus (USB).

8. A system in accordance with claim 1, wherein the host computer is a handheld device.

9. A system in accordance with claim 1, wherein the communication between the processor unit and the handheld device is accomplished by available communication protocol on the handheld unit.

10. A system in accordance with claim 1, wherein the processor unit is embedded in the handheld device so that the probe unit directly communicates with the processor unit in the handheld unit.
